(19) United States
(12) Patent Application Publication
(10) Pub. No.: US 2026/0247178 A1
(43) Pub. Date: Aug. 20, 2026

(54) METHOD FOR MODEL UPDATE AND COMMUNICATION DEVICE

(71) Applicant: GUANGDONG OPPO MOBILE TELECOMMUNICATIONS CORP., LTD., Dongguan (CN)

(72) Inventors: Xue LIN, Dongguan (CN); Hao WU, Dongguan (CN); Xin YOU, Dongguan (CN)

(21) Appl. No.: 19/647,751

(22) Filed: Apr. 14, 2026

Related U.S. Application Data
(63) Continuation of application No. PCT/CN2023/135676, filed on Nov. 30, 2023.

(51) Int. Cl. H04W 24/02; G06N 20/00

(52) U.S. Cl. CPC H04W 24/02; G06N 20/00

(57) ABSTRACT

A method for model update includes the following. A first communication device receives first information, where the first information is used for updating a first model. During a process of updating the first model based on the first information, the first communication device performs a first action when the first model is in an update abnormal state.

### CROSS-REFERENCE TO RELATED APPLICATION(S)

This application is a continuation of International Application No. PCT/CN2023/135676, filed Nov. 30, 2023, the entire disclosure of which is incorporated herein by reference.

### TECHNICAL FIELD

This disclosure relates to the field of communication, and more particularly, to a method for model update and a communication device.

### RELATED ART

Models such as artificial intelligence (AI)/machine learning (ML) models can be transmitted through an air interface or in other manners. With the change in a scenario and/or configuration, a receiving end of a model may need to update the model, such that the model operating at the receiving end is adapted to the current scenario and/or configuration.

### SUMMARY

Embodiments of the present disclosure provide a method for model update. The method includes the following. A first communication device receives first information, where the first information is used for updating a first model. During a process of updating the first model based on the first information, the first communication device performs a first action when the first model is in an update abnormal state.

Embodiments of the present disclosure provide a first communication device. The first communication device includes a processor and a memory. The memory is configured to store a computer program. The processor is configured to invoke and execute the computer program stored in the memory to enable the first communication device to perform the aforementioned method for model update.

Embodiments of the present disclosure provide a second communication device. The second communication device includes a processor and a memory. The memory is configured to store a computer program. The processor is configured to invoke and execute the computer program stored in the memory to enable the second communication device to send first information, where the first information is used for updating a first model.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1 is a schematic diagram of an application scenario according to embodiments of the present disclosure.

FIG. 2 is a schematic diagram of layers of an artificial intelligence (AI)/machine learning (ML) model.

FIG. 3 is a schematic diagram of a layered modular structure of an AI/ML model.

FIG. 4 is a schematic flowchart of a method for model update according to an embodiment of the present disclosure.

FIG. 5 is a schematic flowchart of a method for model update according to another embodiment of the present disclosure.

FIG. 6 is a schematic flowchart of a method for model update according to another embodiment of the present disclosure.

FIG. 7 is a schematic flowchart of a method for model update according to an embodiment of the present disclosure.

FIG. 8 is a schematic flowchart of a method for model update according to another embodiment of the present disclosure.

FIG. 9 is a schematic flowchart of a method for model update according to another embodiment of the present disclosure.

FIG. 10 is a schematic block diagram of a first communication device according to an embodiment of the present disclosure.

FIG. 11 is a schematic block diagram of a first communication device according to another embodiment of the present disclosure.

FIG. 12 is a schematic block diagram of a second communication device according to an embodiment of the present disclosure.

FIG. 13 is a schematic block diagram of a communication device according to embodiments of the present disclosure.

FIG. 14 is a schematic block diagram of a chip according to embodiments of the present disclosure.

FIG. 15 is a schematic block diagram of a communication system according to embodiments of the present disclosure.

### DETAILED DESCRIPTION

The following will describe technical solutions of embodiments of the disclosure with reference to the accompanying drawings in embodiments of the disclosure.

The technical solutions in embodiments of the disclosure are applicable to various communication systems, for example, a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi), a 5^{th} generation (5G) system, or other communication systems.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, vehicle to everything (V2X) communication, etc. Embodiments of the disclosure can also be applied to these communication systems.

In an embodiment, a communication system in embodiments of the disclosure may be applied to a carrier aggregation (CA) scenario, a dual connectivity (DC) scenario, or a standalone (SA) network deployment scenario.

In an embodiment, the communication system in implementations of the disclosure is applicable to an unlicensed spectrum, and an unlicensed spectrum may be regarded as a shared spectrum. Or the communication system in embodiments of the disclosure is applicable to a licensed spectrum, and a licensed spectrum may be regarded as a non-shared spectrum.

Various embodiments of the disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, a user device, etc. The terminal device may be a station (ST) in a WLAN, a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, and a terminal device in a next-generation communication system, for example, a terminal device in an NR network, a terminal device in a future evolved public land mobile network (PLMN), etc.

In embodiments of the disclosure, the terminal device can be deployed on land, which includes indoor or outdoor, handheld, wearable, or in-vehicle. The terminal device can also be deployed on water (such as ships, etc.). The terminal device can also be deployed in the air (such as airplanes, balloons, satellites, etc.).

In embodiments of the disclosure, the terminal device can be a mobile phone, a pad, a computer with wireless transceiver functions, a virtual reality (VR) terminal device, an augmented reality (AR) terminal device, a wireless terminal device in industrial control, a wireless terminal device in self-driving, a wireless terminal device in remote medicine, a wireless terminal device in smart grid, a wireless terminal device in transportation safety, a wireless terminal device in smart city, a wireless terminal device in smart home, etc.

By way of explanation rather than limitation, in embodiments of the disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, and the network device may be an access point (AP) in a WLAN, an evolutional Node B (eNB or eNodeB) in LTE, or a relay station or AP, or an in-vehicle device, a wearable device, a network device (gNB) in an NR network, a network device in a future evolved PLMN, a network device in an NTN, etc.

By way of explanation rather than limitation, in embodiments of the disclosure, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In embodiments of the disclosure, the network device provides services for a cell, and the terminal device communicates with the network device on a transmission resource (for example, a frequency-domain resource or a spectrum resource) for the cell. The cell may be a cell corresponding to the network device (for example, a base station). The cell may correspond to a macro base station, or may correspond to a base station corresponding to a small cell. The small cell may include: a metro cell, a micro cell, a pico cell, a femto cell, and the like. These small cells are characterized by small coverage and low transmission power and are adapted to provide data transmission service with high-rate.

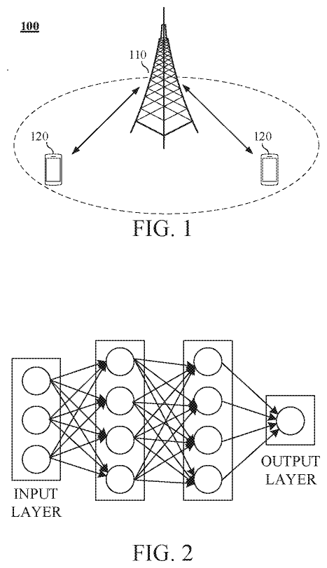

FIG. 1 exemplarily illustrates a communication system 100. The communication system includes one network device 110 and two terminal devices 120. In an implementation, the communication system 100 may include multiple network devices 110, and the coverage area of each network device 110 may include other numbers of terminal devices 120. Embodiments of the disclosure are not limited in this regard.

In an implementation, the communication system 100 may further include other network entities such as a mobility management entity (MME) and an access and mobility management function (AMF). Embodiments of the disclosure are not limited in this regard. The network device may include an access-network device and a core-network device, that is, the wireless communication system further includes multiple core-networks for communicating with the access-network device. The access-network device may be an evolutional node B (eNB or eNodeB), a macro base station, a micro base station (also referred to as a “small base station”), a pico base station, an access point (AP), a transmission point (TP), or a new generation Node B (gNodeB) in a long-term evolution (LTE) system, a next radio (NR) system, an authorized auxiliary access long-term evolution (LAA-LTE) system, etc.

It should be understood that, a device with communication functions in a network or system in embodiments of the disclosure may be referred to as a communication device. For example, as illustrated in FIG. 1, the communication device may include a network device and a terminal device with communication functions. The network device and the terminal device may be the specific devices in embodiments of the disclosure, which will not be repeated herein. The communication device may further include other devices in the communication system, such as a network controller, a mobility management entity, or other network entities. Embodiments of the disclosure are not limited in this regard.

It should be understood that, the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

It should be understood that, “indication” referred to in embodiments of the disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that that there is an association relationship between A and B.

In the elaboration of embodiments of the disclosure, the term “correspondence” may mean that there is a direct or indirect correspondence between the two, may mean that there is an association between the two, or may mean a relationship of indicating and indicated, configuring and configured, etc.

In order for better understanding of technical solutions of embodiments of the disclosure, technologies related to the embodiments of the disclosure will be elaborated below. The following related art as an optional scheme can be arbitrarily combined with the technical solutions of embodiments of the disclosure, which shall all belong to the protection scope of embodiments of the disclosure.
1. Artificial intelligence (AI)/machine learning (ML) model transmission

AI/ML model transmission includes transmission of an AI/ML model over an air interface. Transmitted content may include model parameters of a model structure known to a receiving end, a new model with model parameters, etc. The transmitted content may include a complete model or part of a model.

Model transmission is from a network side to a UE side. A network-side node may be a gNB, a core network node other than a location management function (LMF), an LMF, or a server (such as an over the top (OTT) server (which refers to providing various application services to users through the Internet) and an operation administration and maintenance (OAM) device). 3GPP currently defines 7 model transmission solutions as follows.
Solution 1a, the gNB transmits the AI/ML model to the UE through radio resource control (RRC) signaling.
Solution 2a, the core network node (other than the LMF) transmits the AI/ML model to the UE through non-access stratum (NAS) signaling.
Solution 3a, the LMF transmits the AI/ML model to the UE through LTE positioning protocol (LPP) signaling.
Solution 1b, the gNB transmits the AI/ML model to the UE through a user plane.
Solution 2b, the core network node (other than the LMF) transmits the AI/ML model to the UE through the user plane.
Solution 3b, the LMF transmits the AI/ML model to the UE through the user plane.
Solution 4, the server (such as OAM, OTT) transmits the AI/ML model to the UE (for example, which is 3GPP-invisible, that is, a process of model transmission reuses the data/signaling transmission manner defined by 3GPP).
2. AI/ML model segmentation

An AI/ML model may include a deep learning model. As illustrated in FIG. 2, an exemplary model is composed of multiple layers, and each layer includes multiple nodes. The number, arrangement, and connection manner of the multiple layers are referred to as a structure of the model. Nodes and edges in the model have corresponding weight values for adjusting the processing capability of the model. The weight values are referred to as parameters of the model. One AI/ML model includes a model structure and model parameters.

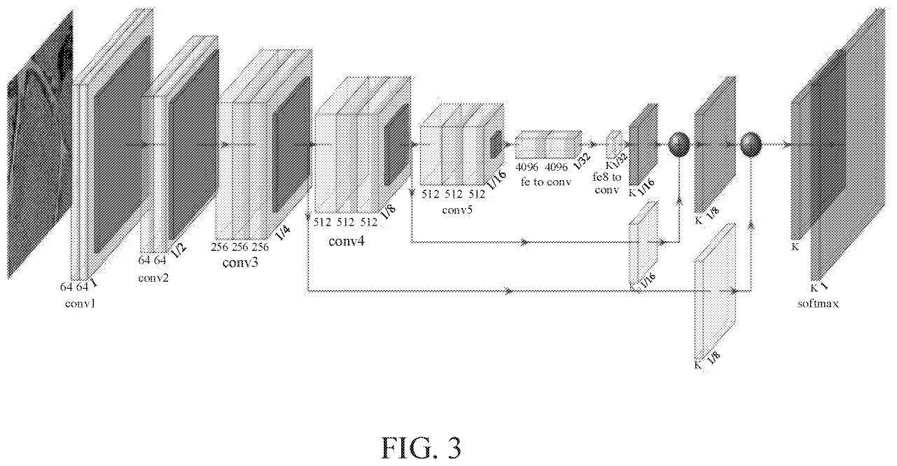

Considering the layered structure of the model, the model structure can be further divided into different modules, as illustrated in FIG. 3. Modules in the model can be replaced as needed to achieve different performances. A module may be one layer in a neural network or composed of multiple layers of the neural network. The number of models/modules commonly used in AI/ML technologies is limited. For example, the model is usually a long short term memory (LSTM) model or a transformer model, and modules therein may include a fully connected layer, a convolutional layer, etc. For example, as illustrated in FIG. 3, the convolutional layers conv1, conv2, conv3, conv4, and conv5 in the model may be one module or multiple modules. For example, conv1, conv2, and conv3 form one module, and conv4 and conv5 form another module. For another example, “fe to conv” and “fe8 to conv” in the model may be one module, each layer K may be one module, and an activation layer (softmax) may be one module.

For AI/ML models using the same model structure, different model IDs may be assigned depending on deployment locations, implementation scenarios, etc., for the models. A model ID can be understood by both a network side and a UE side, that is, either side can determine the function, the structure, the parameter, etc. of the model according to the model ID (and auxiliary meta information (meta info), etc.).

However, if the performance gain of the AI/ML model depends on overfitting to a specific region, the model has relatively limited application scenarios and is usually only applicable to the specific region (such as a single cell) or a specific configuration. For a mobile terminal, when a scenario and/or a configuration changes, the terminal needs to update the model in a timely manner to adapt the model operating on the terminal to the current scenario and/or configuration.

Constrained by storage capacity, the terminal usually cannot store all AI/ML models to cope with changes in the scenario and the configuration, and needs to rely on a model transmission mechanism between the terminal and the network side to replace or update the model. Considering the similarity between different model structures and different services, it is unnecessary for the network side to transmit a complete model in every model transmission, and only needs to transmit a distinct part. For example, the model structure or model parameters of the model are modularized. When the model needs to be updated, only part of model/modules need to be added, released, or replaced, thereby realizing a lightweight model transmission and improving the efficiency of model transmission.

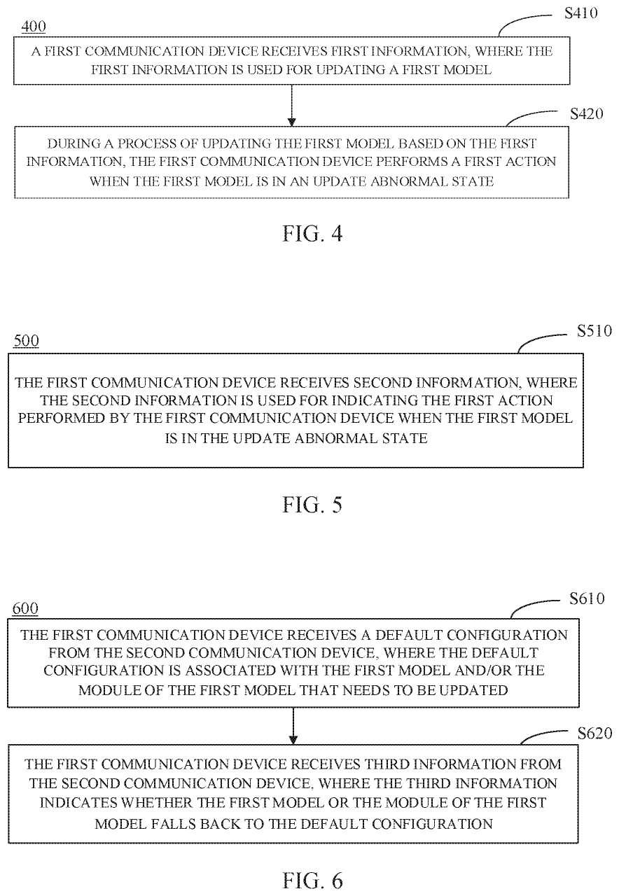

FIG. 4 is a schematic flowchart of a method 400 for model update according to an embodiment of the present disclosure. The method may optionally be applied to the system illustrated in FIG. 1, but is not limited thereto. The method includes at least part of the following.
S410, a first communication device receives first information, where the first information is used for updating a first model.
S420, during a process of updating the first model based on the first information, the first communication device performs a first action when the first model is in an update abnormal state.

In embodiments of the present disclosure, the first communication device may receive the first information from a second communication device. Content of a model such as AI/ML model can be transmitted between the first communication device and the second communication device through an air interface, a sidelink, etc. For example, the first communication device is a terminal, and the second communication device is a network device. For another example, the first communication device is a first terminal, and the second communication device is a second terminal. The content transmitted between the first communication device and the second communication device may include a complete model or part of a model, such as part of structure and/or part of parameters of the model. The first information may be used for updating a complete first model or part of the first model. The first information may also be referred to as update information, model update information, module update information, etc.

In embodiments of the present disclosure, the first information may include the entire structure, all parameters, part of structure, or part of parameters of the first model that need to be updated. The first communication device may update the first model based on the first information. For example, the entire structure, all the parameters, the part of structure, or the part of parameters of the first model are updated. During the process of updating the first model, some abnormal cases may occur, such as abnormal decoding of the first information, or abnormal compliance check of the first information. In the abnormal cases, the first model may be considered as being in the update abnormal state. When the first model is in the update abnormal state, the first communication device may perform one or more first actions, so that the first model or another related model can continue to operate in the first communication device.

In an implementation, the first model includes one or more modules, and the first information is used for indicating update-related information of the one or more modules in the first model. For example, the structure and/or parameters of a model may be divided into one or more modules. For example, the structure of a model may be divided into module #1, module #2, and module #3, and the parameters of the model may be divided into module #4 and module #5. The first information may indicate the update-related information of the one or more modules, such as a name, an identifier (ID), etc., of the model structure and/or the model parameter that needs to be updated.

In an implementation, the update abnormal state includes at least one of: a decoding failure of the first information, and a compliance check failure of the first information.

In embodiments of the present disclosure, the first communication device may perform the first action when the decoding failure of the first information occurs. For example, the decoding failure may include one or more of: a mismatch of compilation formats, a mismatch of compression algorithms, data packet loss, etc. The first communication device may perform the first action when the compliance check failure of the first information occurs. For another example, the compliance check failure may include one or more of: a mismatch between a configuration and a terminal capability, a mismatch between a model parameter and a model structure, etc.

In an implementation, the first communication device performs the first action as follows. The first communication device sends a first report, where the first report is used for indicating update abnormality information of the first model.

In an implementation, the first report includes at least one of:
an index of the first model;
an ID of a module of the first model;
a failure type of the first model or the module of the first model;
a failure cause of the first model or the module of the first model;
failure-related auxiliary information of the first model or the module of the first model; and
an action indication of the first communication device.

In embodiments of the present disclosure, the index of the first model in the first report may be an index of a model with an abnormality. The ID of the module of the first model in the first report may be an ID of a module with an abnormality in the first model. For example, the first information includes 4 updating modules of the first model, among which module #1, module #2, and module #3 have no abnormality, but module #4 cannot be decoded correctly. The first report may include at least one of the ID, the failure type, the failure cause, and the failure-related auxiliary information of module #4.

In an implementation, the failure type includes the decoding failure and/or the compliance check failure.

In an implementation, the failure cause includes a decoding failure cause and/or a compliance check failure cause. The decoding failure cause includes at least one of: the mismatch of compilation formats, the mismatch of compression algorithms, and the data packet loss. The compliance check failure cause includes at least one of: the mismatch between the configuration and the terminal capability, and the mismatch between the model parameter and the model structure.

In an implementation, the failure-related auxiliary information includes at least one of a time when a failure occurs, a cell ID at the time of the failure, and location information at the time of the failure.

In an implementation, the action indication of the first communication device includes whether the first communication device performs a fallback action and/or the fallback action performed by the first communication device.

In an implementation, the first communication device performs the first action as follows. The first communication device performs the fallback action.

In an implementation, the fallback action includes: falling back to an original model, falling back to an original module, falling back to a default module, falling back to a default model, or falling back to a legacy mechanism. For example, the original model of a beam model is model A, and the first model after one or more updates is model B. During the UE updating part of the structure and/or parameters of model B according to the first information, if an abnormality such as the decoding failure or the compliance check failure of the first information occurs, the UE may fall back to model A and continue to operate model A subsequently. For another example, the default model of the beam model is model C, and the first model after one or more updates is model B. During the UE updating part of the structure and/or parameters of model B, if an abnormality occurs, the UE may fall back to model C and continue to operate model C subsequently. For another example, the legacy mechanism corresponding to the beam model includes that the UE performs L1 measurement on a beam (reference signal corresponding to the beam) based on a network configuration and reports the L1 measurement result of the beam to the network. The aforementioned beam model is merely an example and not a limitation, and other types of models such as a positioning model, a channel state information (CSI) prediction model, a CSI compression model, a trajectory prediction model, etc., may also be applicable.

In an implementation, the method for model update further includes the following. S430, the first communication device determines the first action to be performed based on a module importance level. In embodiments of the present disclosure, when the priority of the module satisfies a certain condition, the corresponding first action may be performed. In an example, the priorities of 6 parameter modules of the first model are {0, 1, 2, 3, 4, 5} respectively, where 0 represents the highest priority and 5 represents the lowest priority. For example, if the priority of the module with the decoding failure is the lowest priority 5, the UE may fall back to the original model/module. For another example, if the priority of the module with the compliance check failure is 4, which does not reach a priority threshold 3, the UE may fall back to the default model/module. For another example, if the priority of the module with the decoding failure is 3, 4, or 5, which is not the highest priority, the UE may fall back to the original model/module or the default model/module. For another example, if the priority of the module with the compliance check failure is 0, which is the highest priority, the UE falls back to the legacy mechanism.

In an implementation, the module importance level includes the priority of the module and/or the priority threshold, and the priority of the module corresponds to the first action. In embodiments of the present disclosure, the priority of the module and the priority threshold may be used independently or in combination. For example, if the value of the priority of the module is higher than the priority threshold, one action is performed, and if the value of the priority of the module is not higher than the priority threshold, another action is performed. The priority of the module may correspond to the first action. For example, priorities 3, 4, and 5 correspond to Action1, priority 2 corresponds to Action2, and priority 1 corresponds to Action3.

In an implementation, the first communication device performs the first action as follows. The first communication device maintains the operation of the first model. In embodiments of the present disclosure, after receiving a first message, the first communication device may determine whether to stop the operation of the first model. In one case, the first communication device stops the operation of the first model and determines whether fallback is needed according to a state of model update. If the fallback is needed, reference may be made to the aforementioned fallback action. In another case, the first communication device maintains the operation of the first model and continues to operate the first model if the update fails.

FIG. 5 is a schematic flowchart of a method 500 for model update according to another embodiment of the present disclosure. The method may include one or more features of the aforementioned method for model update. In an implementation, the method for model update further includes the following.
S510, the first communication device receives second information, where the second information is used for indicating the first action performed by the first communication device when the first model is in the update abnormal state. This step may be combined with S410 and S420. For example, S510 is performed first, followed by S410 and S420. For another example, S410 is performed first, followed by S510 and then S420.

In embodiments of the present disclosure, according to the received second information, the first communication device may determine the first action performed when the first model is in the update abnormal state. The first action may be the sending of the first report or the fallback action described in the aforementioned embodiments. For example, if the received second information indicates that the first action corresponding to the first model is falling back to the original model or the default model, the first communication device can fall back to the original model or the default model when the decoding failure and/or the compliance check failure of the first information occurs. For another example, if the received second information indicates that the first action corresponding to the first model is falling back to the legacy mechanism, the first communication device can fall back to the legacy mechanism when the decoding failure and/or the compliance check failure of the first information occurs.

In an implementation, the second information is associated with the first model and/or the module of the first model that needs to be updated, and the second information is used for indicating the first action corresponding to the first model and/or the module of the first model that needs to be updated. For example, one piece of second information is associated with one or more first models that need to be updated, and the second information can indicate the first action(s) corresponding to the associated one or more first models in the update abnormal state. One model may correspond to one action, or multiple models may correspond to the same action. For another example, one piece of second information is associated with one or more modules of the first model that need to be updated, and the second information may indicate the first action(s) corresponding to the associated one or more modules in the update abnormal state. One module may correspond to one action, or multiple modules may correspond to the same action.

In an implementation, the second information is in model information. When the second communication device sends content of a model (such as the original model) to the first communication device, the second information may be carried in the model information. In addition, the second information and the first information may be sent together or separately.

In an implementation, the first communication device performs the first action as follows. The first communication device performs the fallback action based on performance of the original model or a module of the original model (referred to as the original module for short). When the decoding failure and/or the compliance check failure of the first information occurs, if the performance of the original model or the original module is good, satisfying a certain condition, the first communication device may fall back to the original model or the original module; otherwise, the first communication device may fall back to the default model, the default module, or the legacy mechanism.

In an implementation, the first communication device performs the fallback action based on the performance of the original model or the original module as follows.

When the performance of the original model or the original module is higher than a performance indicator threshold, the first communication device falls back to the original model or the original module.

When the performance of the original model or the original module is not higher than the performance indicator threshold, the first communication device falls back to the default model, the default module, or the legacy mechanism.

In embodiments of the present disclosure, whether the performance of the original model or the original module is good or poor can be determined based on the performance indicator threshold. For example, one original model corresponds to one or more performance indicator thresholds. If each aspect of the performance of the original model is higher than the corresponding performance indicator threshold, the original model may be considered to have good performance; otherwise, the original model may be considered to have poor performance. For another example, one original module corresponds to one or more performance indicator thresholds. If each aspect of the performance of the original module is higher than the corresponding performance indicator threshold, the original module may be considered to have good performance; otherwise, the original module may be considered to have poor performance. Alternatively, if the number of aspects of the performance higher than the corresponding thresholds reaches N (N may be understood as a threshold), the original model or the original module may be considered to have good performance; otherwise, the original model or the original module may be considered to have poor performance. Alternatively, in a certain original model, if the number of modules with performance higher than the corresponding thresholds reaches M (M may be understood as a threshold), the original model may be considered to have good performance; otherwise, the original model may be considered to have poor performance.

In an implementation, the first communication device performs the first action as follows. The first communication device performs a default action based on the first model, where the default action includes an action, pre-configured by the second communication device, of the first communication device when the first model is in the update abnormal state. In embodiments of the present disclosure, the second communication device may pre-configure the default action of the first communication device, and the first communication device may perform the default action when the decoding failure and/or the compliance check failure of the first information used for updating the first model occurs. For example, the network pre-configures a default action of the UE before a failure occurs. The UE may perform the default action of the UE when the decoding failure and/or the compliance check failure of the first information occurs.

In an implementation, the default action includes at least one of: falling back to the original model or the original module, falling back to the default model or the default module, and falling back to the legacy mechanism. For example, if the default action of the UE pre-configured by the network is falling back to the original model or the original module, the UE may fall back to the original model or the original module when the decoding of the first information fails. For another example, if the default action of the UE pre-configured by the network is falling back to the default model or the default module, the UE may fall back to the default model or the default module when the compliance check of the first information fails. For another example, if the default action of the UE pre-configured by the network is falling back to the legacy mechanism, the UE may fall back to the legacy mechanism when the decoding and the compliance check of the first information fail.

In an implementation, the method further includes the following. The first communication device reports capability information to the second communication device, where the capability information includes at least one of: whether the first communication device supports falling back to the original model or the original module, whether the first communication device supports falling back to the default model or the default module, and a precision requirement of the first communication device for model prediction. For example, the UE may report its own UE capability to the network in advance. If the UE supports falling back to the original model or the original module, the default action of the UE configurable by the network may be falling back to the original model or the original module.

FIG. 6 is a schematic flowchart of a method 600 for model update according to another embodiment of the present disclosure. The method may optionally be applied to the system illustrated in FIG. 1, but is not limited thereto. The method includes at least part of the following.
S610, the first communication device receives a default configuration from the second communication device, where the default configuration is associated with the first model and/or the module of the first model that needs to be updated. The method may further include one or more features of the aforementioned method for model update. For example, during the aforementioned process of updating the model, the first communication device may operate the default model or the default module corresponding to the default configuration when the decoding failure and/or the compliance check failure of the first information occurs.

In an implementation, the default configuration is in the model information. For example, during model transmission and/or update, the network provides the UE with the default configuration corresponding to a target model and/or a module of the target model. The default configuration may be transmitted together in the model information sent by the network.

In an implementation, the method further includes the following. The first communication device receives default-configuration update information, where the default-configuration update information is in at least one of a system broadcast message and/or a terminal-dedicated RRC message. The first communication device updates the default configuration according to the default-configuration update information. For another example, the network updates the default configuration of the model or the module of the model through the system broadcast message or a UE-dedicated RRC message.

In an implementation, the default configuration is associated with configuration validity-related information. For example, the configuration validity-related information is location information, and the location information includes one or more physical cell identities (PCIs). The UE checks whether the PCI of a currently accessed cell is included in the location information to determine whether the default configuration is valid. If the PCI of the currently accessed cell is included in the location information, the default information is determined to be a valid default configuration; otherwise, the default information is an invalid default configuration.

In an implementation, a case of falling back to or using the default configuration include at least one of the following:
(1) A decoding failure and/or a compliance check failure occurs during the process of updating the first model (with reference to the relevant description in the aforementioned method embodiments).
(2) The first communication device performs cell handover.
(3) A change occurs in radio resource configuration information related to the first model. For example, a radio resource configuration adapted to the current model/module is configuration A. When a radio resource configuration received by the UE through the system broadcast message or the UE-dedicated RRC message is configuration B, the UE uses the default configuration corresponding to the model/module.
(4) Based on a monitoring result of the first model, it is determined that the performance of the first model does not satisfy a pre-configured threshold. For example, if the performance of the model is found to be lower than the pre-configured threshold based on the model monitoring result, the UE uses the default configuration corresponding to the model/module.

In an implementation, a behavior of the first communication device complies with a case of falling back to the default configuration, under at least one of the following conditions:
a case of falling back to or using the default configuration occurs at the first communication device;
the first communication device is unable to send a first report, unable to fall back to the original model or the original module, or unable to fall back to the legacy mechanism; and
the first communication device determines not to send the first report, not to fall back to the original model or the original module, or not to fall back to the legacy mechanism.

For example, if the case (1), (2), (3), or (4) for falling back to or using the default configuration occurs at the first communication device and the first communication device is unable to send the first report, or is unable to fall back to the original model or the original module, or is unable to fall back to the legacy mechanism, the first communication device can fall back to the default configuration such as the default model or the default module.

For another example, if the case (1), (2), (3), or (4) for falling back to or using the default configuration occurs at the first communication device and the first communication device determines not to send the first report, or not to fall back to the original model or the original module, or not to fall back to the legacy mechanism, the first communication device can fall back to the default configuration such as the default model or the default module.

For another example, if the first communication device does not support sending the first report, or does not support falling back to the original model or the original module, or does not support falling back to the legacy mechanism, the first communication device can fall back to the default configuration such as the default model or the default module.

In an implementation, the method for model update further includes the following.
S620, the first communication device receives third information from the second communication device, where the third information indicates whether the first model or the module of the first model falls back to the default configuration.

For example, a network indication received by the UE indicates the UE to perform the model update, the model transmission, the cell handover, or the configuration update, and further indicates whether the current model of the UE or part of modules of the current model need to fall back to the default configuration. For another example, the network indication may be included in the model information, for example, to indicate to the UE whether to fall back to the default configuration when the aforementioned condition (1), (2), (3), or (4) occurs.

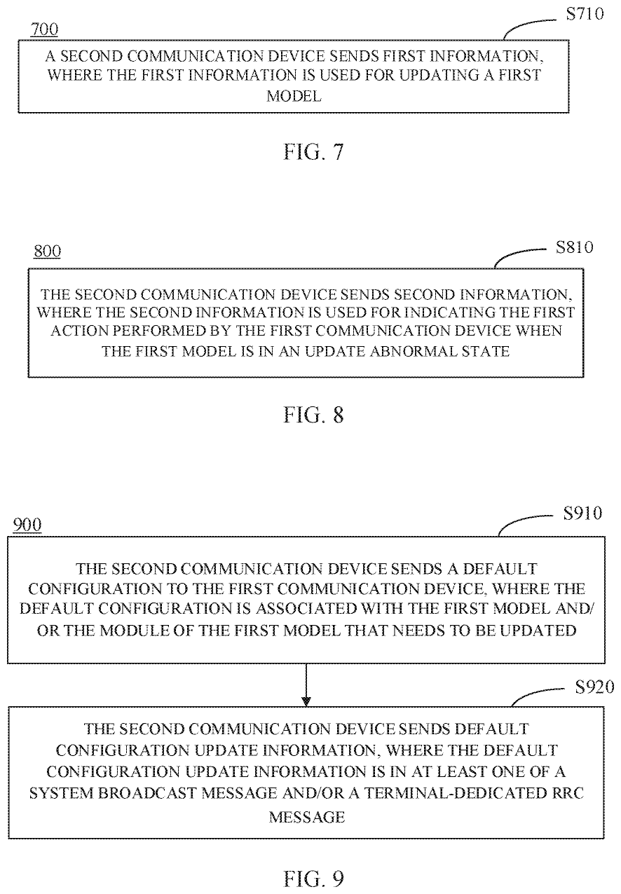

FIG. 7 is a schematic flowchart of a method 700 for model update according to an embodiment of the present disclosure. The method may optionally be applied to the system illustrated in FIG. 1, but is not limited thereto. The method includes at least part of the following.
S710, a second communication device sends first information, where the first information is used for updating a first model.

In an implementation, the second communication device receives a first report, where the first report is used for indicating update abnormality information of the first model.

In an implementation, the first report includes at least one of:
an index of the first model;
an ID of a module of the first model;
a failure type of the first model or a module of the first model;
a failure cause of the first model or the module of the first model;
failure-related auxiliary information of the first model or the module of the first model; and
an action indication of a first communication device.

In an implementation, the failure type includes a decoding failure and/or a compliance check failure. The failure cause includes a decoding failure cause and/or a compliance check failure cause. The decoding failure cause includes at least one of a mismatch of compilation formats, a mismatch of compression algorithms, and data packet loss. The compliance check failure cause includes at least one of a mismatch between a configuration and a terminal capability, and a mismatch between a model parameter and a model structure. The failure-related auxiliary information includes at least one of a time when a failure occurs, a cell ID at the time of the failure, and location information at the time of the failure. The action indication of the first communication device includes whether the first communication device performs a fallback action and/or the fallback action performed by the first communication device.

In an implementation, the fallback action includes falling back to an original model, falling back to an original module, falling back to a default module, falling back to a default model, or falling back to a legacy mechanism.

FIG. 8 is a schematic flowchart of a method 800 for model update according to another embodiment of the present disclosure. The method may include one or more features of the aforementioned method for model update. In an implementation, the method for model update further includes the following.
S810, the second communication device sends second information, where the second information is used for indicating the first action performed by the first communication device when the first model is in an update abnormal state.

In an implementation, the second information is associated with the first model and/or the module of the first model. The second information is used for indicating the first action corresponding to the first model and/or the module of the first model that needs to be updated.

In an implementation, the second information is in model information.

FIG. 9 is a schematic flowchart of a method 900 for model update according to another embodiment of the present disclosure. The method may include one or more features of the aforementioned method for model update. The method may optionally be applied to the system illustrated in FIG. 1, but is not limited thereto. The method includes at least part of the following.
S910, the second communication device sends a default configuration to the first communication device, where the default configuration is associated with the first model and/or the module of the first model that needs to be updated.

In an implementation, the default configuration is in the model information.

In an implementation, the method further includes the following. S920, the second communication device sends default-configuration update information, where the default-configuration update information is in at least one of a system broadcast message and/or a terminal-dedicated RRC message. The default-configuration update information is used for indicating the first communication device to update the default configuration.

In an implementation, a case of falling back to or using the default configuration include at least one of the following. The decoding failure and/or the compliance check failure occurs during a process of updating the first model. The first communication device performs cell handover. A change occurs in radio resource configuration information related to the first model. Based on a monitoring result of the first model, it is determined that performance of the first model does not satisfy a pre-configured threshold.

In an implementation, the method for model update further includes the following. S930, the second communication device sends third information to the first communication device, where the third information indicates whether the first model or the module of the first model falls back to the default configuration.

For specific examples of the second communication device performing the methods 700, 800, and 900 for model update in the embodiment, reference may be made to the relevant description about the second communication device in the aforementioned methods 400, 500, and 600 for model update. For the sake of brevity, details are not repeated herein.

Based on the aforementioned lightweight model transmission manner, embodiments of the present disclosure provide a failure management mechanism. For example, a terminal can perform subsequent actions when the terminal cannot decode a received model/module or an updated model/module cannot match a current model.

The failure management mechanism based on the lightweight model transmission may include the following.
1. A UE receives first information, where the first information is used for indicating to the UE to update a target model.
2. The UE performs a first operation on the model/module included in the first information, including:
2-1. Determining whether the received model/module can be successfully decoded;
2-2. Performing a compliance check on the model/module.
3. Based on the aforementioned first operation, if at least one of the checks 2-1 and 2-2 does not pass, the action of the UE may include the following:
3-1. Sending a first report to a network, where the first report includes a failure type and an ID of the module that cannot be decoded or adapted.
3-2. Falling back to an original model or an original module.
3-3. Falling back to a default configuration.
3-4. Falling back to a legacy mechanism.
4. For 3-1, 3-2, 3-3, and 3-4 in step 3, the action of the UE further includes the following:
4-1. Determining to perform at least one of the aforementioned actions 3-1, 3-2, 3-3, and 3-4 based on an importance level of the model or the module.
4-2. Determining to perform at least one of the aforementioned actions 3-1, 3-2, 3-3, and 3-4 based on a network indication.

### Example 1

1. The UE is currently operating a first model. For example, assuming the first model is used for beam management, model parameters of the first model may be divided into 4 modules, namely module #1, module #2, module #3, and module #4.
2. The UE receives first information sent by the network. For example, the first information indicates to the UE to update the parameter module #1 and the parameter module #2 of the first model to be parameter module #1′ and parameter module #2′. Optionally, the first information may further indicate to the UE update information for multiple target models. For example, in addition to indicating the update information for the first model, the first information may also indicate to the UE to update parameter module #1 of a second model.
3. The UE performs decoding and/or compliance check on the parameter module #1 and the parameter module #2 (for example, to determine whether the model/module can be adapted to the target model/UE). If a decoding failure, a compliance check failure, or another failure occurs, the action of the UE may include at least one of the following.
3-1. The UE sends the first report to the network, where the first report may include at least one of the following:
a) An index of the model where the decoding failure or the compliance check failure occurs.
b) A failure type, which includes the decoding failure and the compliance check failure.
c) An ID of the module where the decoding failure/compliance check failure occurs.
d) A failure cause. For example, for the decoding failure, the failure cause may include a mismatch of compilation formats, a mismatch of compression algorithms, data packet loss, etc. For the compliance check failure, the failure cause may include a mismatch between the configuration and the UE capability, a mismatch between a model parameter and a model structure, etc.

The first report may further include a time when a failure occurs, a cell ID at the time of the failure, location information at the time of the failure, etc. These information can help the network in subsequent self-optimization. Since these information may not be used for real-time adjustment of the module, this part of the report content may be sent separately from the previous report content.
e) A UE action indication. For example, the UE action indication may include whether the UE performs a fallback action and/or the fallback action performed by the UE. For example, the following 3-2, 3-3, or 3-4 may be understood as the fallback action in a failure case. The fallback action performed by the UE and indicated by the UE action may be 3-2, 3-3, or 3-4.
3-2. Fall back to an original model/module. For example, if the UE fails to decode the parameter module #1′ in the first information, the UE falls back to using the parameter module #1.
3-3. Fall back to a default module or a default model.
3-4. Fall back to a legacy mechanism. For example, if the first model is used for beam management, when the decoding failure or the compliance check failure occurs during a process of updating the model, the UE stops using the first model and falls back to the legacy beam measurement mechanism.
4. For 3-1, 3-2, 3-3, or 3-4 in step 3 above, the action of the UE may further include the following.
4-1. Determine to perform at least one of the aforementioned actions 3-1, 3-2, 3-3, or 3-4 based on an importance level of the module.

For example, priorities of the four parameter modules of the first model are {0, 1, 2, 3} respectively, where 0 represents the highest priority and 3 represents the lowest priority. If the priority of the module with the decoding failure/compliance check failure is the lowest priority (i.e., 3) or a non-highest priority (i.e., 1, 2, or 3), the UE can fall back to the original model/module or the default model/module; otherwise, the UE falls back to the legacy mechanism.

For another example, the network configures a priority threshold for the UE, and the UE determines the action of the UE based on comparison between the priority of the updating module and the priority threshold. For example, if the priority of the updating module is higher than the priority threshold, the UE falls back to the legacy mechanism when the decoding failure/compliance check failure occurs; otherwise, the UE falls back to the original model/module or the default model/module.
4-2. Determine to perform at least one of the aforementioned actions 3-1, 3-2, 3-3, or 3-4 based on a network indication.

For example, the network includes first indication information (an example of the second information in the aforementioned embodiments) in the first information. The first indication information may be used for indicating one or more of the following actions. For the model/module that needs to be updated, when the decoding failure/compliance check failure occurs, the UE performs 3-1, 3-2, 3-3, or 3-4. The first indication information may be associated with each module that needs to be updated or all modules that need to be updated.

For another example, the first indication information is included in model information.
4-3. Determine the action of the UE based on performance of the original model. For example, the network configures a performance indicator threshold for the UE that allows the UE to fall back to the original model/module, and the UE determines whether the performance when operating the original model/module is higher than the performance indicator threshold. If the performance of the UE when operating the original model/module is higher than the performance indicator threshold, the UE falls back to the original model/module when the decoding failure/compliance check failure occurs; otherwise, the UE falls back to the default model/module or the legacy mechanism.
4-4. Determine the action of the UE based on a default configuration. The network pre-configures a default action of the UE before a failure occurs. For example, the aforementioned 3 -3 action is configured by default, and once a failure occurs, the UE directly falls back to the legacy mechanism.

In this case, the UE may report its capability in advance, such as whether the UE supports falling back to the original model/module, the precision requirement of the UE for model prediction, etc.

### Example 2: Default Configuration of the Model or Module

1. The network may configure a default configuration corresponding to a model or each module of the model for the UE. For example, the UE uses the default configuration corresponding to the module in the following cases.
1-1. A decoding failure/compliance check failure occurs during a process of updating the model, such as 3-3 in Example 1.
1-2. The UE performs cell handover.
1-3. A change occurs in radio resource configuration information related to the model.

For example, radio resource configurations adapted to a current model/module are configuration A, configuration B, and configuration C. When the UE receives configuration D through a system broadcast message or a UE-dedicated RRC message, the UE uses the default configuration corresponding to the model/module. The radio resource configuration information adapted to the model/module may be included in model information.
1-4. Performance of the model is lower than a pre-configured threshold based on a model monitoring result.
1-5. Based on a network indication (an example of the third information in the aforementioned embodiments). For example, when the network indicates to the UE to perform model update, model transmission, cell handover, or configuration update, the network simultaneously indicates whether the current model of the UE or part of module of the current model needs to fall back to the default configuration. For another example, the network indication may be included in the model information, that is, the network indication indicates whether the UE falls back to the default configuration when the aforementioned cases 1-1 to 1-4 occur.
1-6. When the aforementioned cases 1-1 to 1-4 occur, the UE is unable to perform action 3-1, 3-2, or 3-4 in Example 1, or the UE determines not to perform action 3-1, 3-2, or 3-4, and then the UE falls back to the default model/module. For example, the UE capability does not support performing action 3-1, 3-2, or 3-4, or the network does not configure the UE to perform action 3-1, 3-2, or 3-4, or a condition for performing action 3-1, 3-2, or 3-4 is not satisfied, such as 4-3 in Example 1.
2. The default configuration of the model and/or the module may be included in the model information. For example, during model transmission/update, the network provides the UE with the default configuration corresponding to a target model/target module of the model. For another example, the network updates the default configuration of the model or the module of the model through the system broadcast message or the UE-dedicated RRC message. For another example, the default configuration may be associated with configuration validity-related information, where the configuration validity-related information is location information including one or more PCI. The UE determines whether a PCI of a currently accessed cell is included in the location information to determine a valid default configuration.

In addition, the default configuration can ensure the basic operation performance of the model and has a good generalization ability. However, the UE cannot achieve the optimal performance of the model under a certain cell/configuration by using the configuration. To obtain the optimal performance of the model, the network also needs to update the model based on the current scenario where the UE is in.

According to the solution provided in the embodiments of the present disclosure, the action to be performed by the terminal when the model/module cannot be decoded or the model/module cannot adapt to the current model can be clarified. For example, by performing modularization on a model structure or model parameters of the model, the action to be performed by the terminal when the model/module cannot be decoded or the model/module cannot adapt to the current model can be clarified.

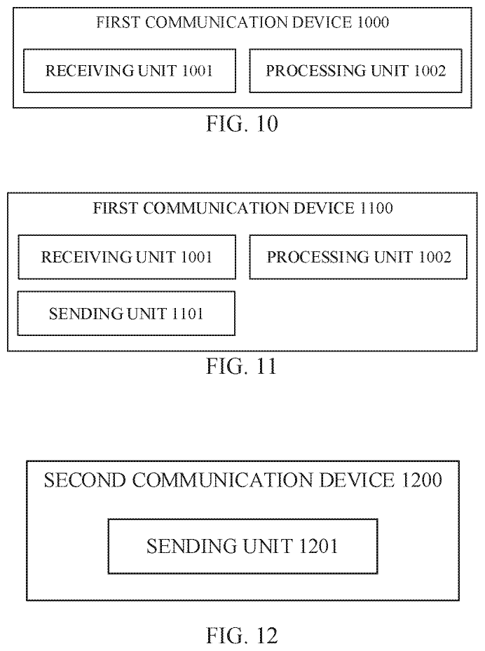

FIG. 10 is a schematic block diagram of a first communication device 1000 according to an embodiment of the present disclosure. The first communication device 1000 includes a receiving unit 1001 and a processing unit 1002. The receiving unit 1001 is configured to receive first information, where the first information is used for updating a first model. The processing unit 1002 is configured to perform a first action when the first model is in an update abnormal state during a process of updating the first model based on the first information.

In an implementation, the first model includes one or more modules, and the first information is used for indicating update-related information of the one or more modules in the first model.

In an implementation, the update abnormal state includes at least one of a decoding failure of the first information and a compliance check failure of the first information.

In an implementation, the processing unit is configured to perform at least one of the following first action. The processing unit is configured to send a first report, where the first report is used for indicating update abnormality information of the first model. The processing unit is further configured to perform a fallback action. The processing unit is further configured to maintain operation of the first model.

In an implementation, the first report includes at least one of:
an index of the first model;
an ID of a module of the first model;
a failure type of the first model or the module of the first model;
a failure cause of the first model or the module of the first model;
failure-related auxiliary information of the first model or the module of the first model; and
an action indication of the first communication device.

In an implementation, the failure type includes the decoding failure and/or the compliance check failure.

In an implementation, the failure cause includes a decoding failure cause and/or a compliance check failure cause. The decoding failure cause includes at least one of a mismatch of compilation formats, a mismatch of compression algorithms, and data packet loss. The compliance check failure cause includes at least one of a mismatch between a configuration and a terminal capability, and a mismatch between a model parameter and a model structure.

In an implementation, the failure-related auxiliary information includes at least one of a time when a failure occurs, a cell ID at the time of the failure, and location information at the time of the failure.

In an implementation, the action indication of the first communication device includes whether the first communication device performs the fallback action and/or the fallback action performed by the first communication device.

In an implementation, the fallback action includes: falling back to an original model, falling back to an original module, falling back to a default module, falling back to a default model, or falling back to a legacy mechanism.

In an implementation, the processing unit is further configured to determine the first action to be performed based on a module importance level.

In an implementation, the module importance level includes a priority of the module and/or a priority threshold, and the priority of the module corresponds with the first action.

In an implementation, the receiving unit 1001 is further configured to receive second information, where the second information is used for indicating the first action performed by the first communication device when the first model is in the update abnormal state.

In an implementation, the second information is associated with the first model and/or the module of the first model that needs to be updated, and the second information is used for indicating the first action corresponding to the first model and/or the module of the first model that needs to be updated.

In an implementation, the second information is in model information.

In an implementation, the processing unit is further configured to perform the fallback action based on performance of the original model or the original module.

In an implementation, the processing unit performs the fallback action based on the performance of the original model or the original module as follows. The processing unit falls back to the original model or the original module if the performance of the original model or the original module is higher than a performance indicator threshold. The processing unit falls back to the default model, the default module, or the legacy mechanism if the performance of the original model or the original module is not higher than the performance indicator threshold.

In an implementation, the processing unit 1002 is further configured to perform a default action based on the first model, where the default action includes an action, pre-configured by a second communication device, of the first communication device when the first model is in the update abnormal state.

In an implementation, the default action includes at least one of: falling back to the original model or the original module, falling back to the default model or the default module, and falling back to the legacy mechanism.

In an implementation, as illustrated in FIG. 11, the first communication device further includes a sending unit 1101. The sending unit 1101 is configured to report capability information to the second communication device, where the capability information includes at least one of the following. Whether the first communication device supports falling back to the original model or the original module, whether the first communication device supports falling back to the default model or the default module, and a precision requirement of the first communication device for model prediction.

In an implementation, the receiving unit 1001 is further configured to receive a default configuration from the second communication device, where the default configuration is associated with the first model and/or the module of the first model that needs to be updated.

In an implementation, the default configuration is in the model information.

In an implementation, the receiving unit 1001 is further configured to receive default-configuration update information, where the default-configuration update information is in at least one of a system broadcast message and/or a terminal-dedicated RRC message. The processing unit is further configured to update the default configuration according to the default-configuration update information.

In an implementation, the default configuration is associated with configuration validity-related information.

In an implementation, a case of falling back to or using the default configuration include at least one of the following. The decoding failure and/or the compliance check failure occurs during a process of updating the first model. The first communication device performs cell handover. A change occurs in radio resource configuration information related to the first model. Based on a monitoring result of the first model, it is determined that performance of the first model does not satisfy a pre-configured threshold.

In an implementation, a behavior of the first communication device complies with a case of falling back to the default configuration, under at least one of the following conditions:
a case of falling back to or using the default configuration occurs at the first communication device;
the first communication device is unable to send a first report, unable to fall back to an original model or an original module, or unable to fall back to a legacy mechanism; and
the first communication device determines not to send the first report, not to fall back to the original model or the original module, or not to fall back to the legacy mechanism.

In an implementation, the receiving unit 1001 is further configured to receive third information from the second communication device, where the third information indicates whether the first model or the module of the first model falls back to the default configuration.

The first communication device 1000 and 1100 of the embodiment of the disclosure can implement the corresponding functions of first communication device in the foregoing method embodiments. For the processes, functions, implementation manners, and beneficial effects corresponding to each module (sub-module, unit, component, etc.) in the first communication device 1000 and 1100, reference can be made to the corresponding descriptions in the above method embodiments, and details are not repeated herein. It should be noted that the functions described for each module (sub-module, unit, component, etc.) in the first communication device 1000 and 1100 of the embodiment of the disclosure can be implemented by different modules (sub-modules, units, components, etc.) or by the same module (sub-module, unit, component, etc.).

FIG. 12 is a schematic block diagram of a second communication device 1200 according to an embodiment of the present disclosure. The second communication device 1200 includes a sending unit 1201 configured to send first information, where the first information is used for updating a first model.

In an implementation, the second communication device receives a first report, where the first report is used for indicating update abnormality information of the first model.

In an implementation, the first report includes at least one of:
an index of the first model;
an ID of a module of the first model;
a failure type of the first model or the module of the first model;
a failure cause of the first model or the module of the first model;
failure-related auxiliary information of the first model or the module of the first model; and
an action indication of the first communication device.

In an implementation, the failure type includes a decoding failure and/or a compliance check failure. The failure cause includes a decoding failure cause and/or a compliance check failure cause. The decoding failure cause includes at least one of a mismatch of compilation formats, a mismatch of compression algorithms, and data packet loss. The compliance check failure cause includes at least one of a mismatch between a configuration and a terminal capability, and a mismatch between a model parameter and a model structure. The failure-related auxiliary information includes at least one of a time when a failure occurs, a cell ID at the time of the failure, and location information at the time of the failure. The action indication of the first communication device includes whether the first communication device performs a fallback action and/or the fallback action performed by the first communication device.

In an implementation, the fallback action includes falling back to an original model, falling back to an original module, falling back to a default module, falling back to a default model, or falling back to a legacy mechanism.

In an implementation, the sending unit 1201 is further configured to send second information, where the second information is used for indicating a first action performed by the first communication device when the first model is in an update abnormal state.

In an implementation, the second information is associated with the first model and/or the module of the first model. The second information is used for indicating the first action corresponding to the first model and/or the module of the first model that needs to be updated.

In an implementation, the second information is in model information.

In an implementation, the sending unit 1201 is further configured to send a default configuration to the first communication device, where the default configuration is associated with the first model and/or the module of the first model that needs to be updated.

In an implementation, the default configuration is in the model information.

In an implementation, the sending unit 1201 is further configured to send default-configuration update information, where the default-configuration update information is in at least one of a system broadcast message and/or a terminal-dedicated RRC message. The default-configuration update information is used for indicating the first communication device to update the default configuration.

In an implementation, a case of falling back to or using the default configuration include at least one of the following. The decoding failure and/or the compliance check failure occurs during a process of updating the first model. The first communication device performs cell handover. A change occurs in radio resource configuration information related to the first model. Based on a monitoring result of the first model, it is determined that performance of the first model does not satisfy a pre-configured threshold

In an implementation, the sending unit 1201 is further configured to send third information to the first communication device, where the third information indicates whether the first model or the module of the first model falls back to the default configuration.

The second communication device 1200 of the embodiment of the disclosure can implement the corresponding functions of second communication device in the foregoing method embodiments. For the processes, functions, implementation manners, and beneficial effects corresponding to each module (sub-module, unit, component, etc.) in the second communication device 1200, reference can be made to the corresponding descriptions in the above method embodiments, and details are not repeated herein. It should be noted that the functions described for each module (sub-module, unit, component, etc.) in the second communication device 1200 of the embodiment of the disclosure can be implemented by different modules (sub-modules, units, components, etc.) or by the same module (sub-module, unit, component, etc.).

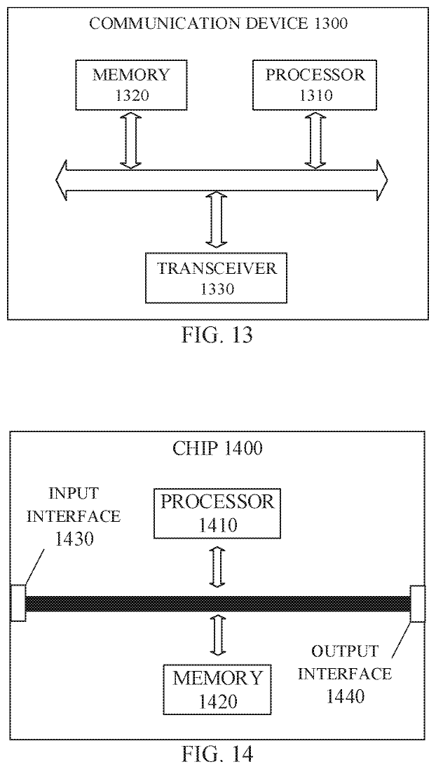

FIG. 13 is a schematic block diagram of a communication device 1300 according to an embodiment of the disclosure. The communication device 1300 includes a processor 1310, and the processor 1310 can invoke and execute a computer program from a memory to cause the communication device 1300 to implement the method in the embodiments of the disclosure.

In an implementation, the communication device 1300 may further include a memory 1320. The processor 1310 can invoke and execute the computer program from the memory 1320 to cause the communication device 1300 to implement the method in the embodiments of the disclosure. The memory 1320 may be an independent component separate from the processor 1310, or may be integrated into the processor 1310.

In an implementation, the communication device 1300 may further include a transceiver 1330, and the processor 1310 can control the transceiver 1330 to communicate with other devices. Specifically, the communication device 1300 can transmit information or data to other devices, or receive information or data transmitted by other devices. The transceiver 1330 may include a transmitter and a receiver. The transceiver 1330 may further include antennas, and the number of antennas may be one or more.

In an implementation, the communication device 1300 may be a first communication device in the embodiments of the disclosure, and the communication device 1300 can implement the corresponding processes performed by the first communication device in each method of the embodiments of the disclosure, which will not be repeated herein for the sake of brevity.

In an implementation, the communication device 1300 may be a second communication device in the embodiments of the disclosure, and the communication device 1300 can implement the corresponding processes performed by the second communication device in each method of the embodiments of the disclosure, which will not be repeated herein for the sake of brevity.

FIG. 14 is a schematic structural diagram of a chip 1400 according to embodiments of the disclosure. The chip 1400 includes a processor 1410, and the processor 1410 can invoke and execute a computer program from a memory to implement the method in the embodiments of the disclosure.

In an implementation, the chip 1400 may further include a memory 1420. The processor 1410 can invoke and execute the computer program from the memory 1420 to implement the method performed by a first communication device or a second communication device in the embodiments of the disclosure. The memory 1420 may be an independent component separate from the processor 1410, or may be integrated into the processor 1410.

In an implementation, the chip 1400 may further include an input interface 1430. The processor 1410 can control the interface 1430 to communicate with other devices or chips. Specifically, the input interface 1430 can obtain information or data transmitted by other devices or chips.

In an implementation, the chip 1400 may further include an output interface 1440. The processor 1410 can control the interface 1440 to communicate with other devices or chips. Specifically, the output interface 1440 can output information or data to other devices or chips.

In an implementation, the chip can be applied to the first communication device in the embodiments of the disclosure, and the chip can implement the corresponding processes performed by the first communication device in each method of the embodiments of the disclosure, which will not be repeated herein for the sake of brevity.

In an implementation, the chip can be applied to the second communication device in the embodiments of the disclosure, and the chip can implement the corresponding processes performed by the second communication device in each method of the embodiments of the disclosure, which will not be repeated herein for the sake of brevity.

The chips applied to the first communication device and the second communication device can be the same chip or different chips.

It should be understood that the chip in embodiments of the disclosure may also be referred to as a system-on-chip (SOC).

The processor described above may be a general-purpose processor, a digital signal processor (DSP), a field programmable gate array (FPGA), an application specific integrated circuit (ASIC), or other programmable logic devices, transistor logic devices or discrete hardware components, etc. The general purpose processor mentioned above may be a microprocessor, or the processor may be any conventional processor or the like.

The memory mentioned above may be a volatile memory or a non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory can be a random access memory (RAM).

It should be understood that, the memory above is intended for illustration rather than limitation. For example, the memory in embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a direct rambus RAM (DR RAM), etc. In other words, the memory in embodiments of the disclosure is intended to include, but is not limited to, these and any other suitable types of memory.

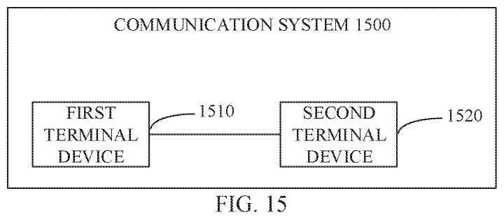

FIG. 15 illustrates a schematic block diagram of a communication system 1500 according to an embodiment of the disclosure. The communication system 1500 includes a first communication device 1510 and a second communication device 1520.

The first communication device 1510 is configured to receive first information, and the first information is used for updating a first model.

The second communication device 1520 is configured to send the first information, and the first information is used for updating the first model.

The first communication device 1510 can be configured to implement corresponding functions implemented by the first communication device in the foregoing methods, and the second terminal 1520 is configured to implement corresponding functions implemented by the second communication device in the foregoing methods, which will not be repeated herein for the sake of brevity.

All or some of the above embodiments can be implemented through software, hardware, firmware, or any other combination thereof. When implemented by software, all or some the above embodiments can be implemented in the form of a computer program product. The computer program product includes one or more computer instructions. When the computer instructions are applied and executed on a computer, all or some the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

It should also be understood that, in various method embodiments of the disclosure, the magnitude of a sequence number of each of the foregoing processes does not mean an execution order, and an execution order of each process should be determined according to a function and an internal logic of the process, which shall not constitute any limitation to an implementation process of embodiments of the disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be described in detail again herein.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

What is claimed is:

1. A method for model update, comprising:
receiving, by a first communication device, first information used for updating a first model; and
performing, by the first communication device, a first action when the first model is in an update abnormal state during a process of updating the first model based on the first information.

2. The method of claim 1, wherein the first model comprises one or more modules, and the first information is used for indicating update-related information of the one or more modules in the first model.

3. The method of claim 1, wherein the update abnormal state comprises at least one of:
a decoding failure of the first information; and
a compliance check failure of the first information.

4. The method of claim 1, wherein performing, by the first communication device, the first action comprises at least one of:
sending, by the first communication device, a first report, wherein the first report is used for indicating update abnormality information of the first model;
performing, by the first communication device, a fallback action; and
maintaining, by the first communication device, operation of the first model.

5. The method of claim 4, wherein the first report comprises at least one of:
an index of the first model;
an identifier (ID) of a module of the first model;
a failure type of the first model or the module of the first model;
a failure cause of the first model or the module of the first model;
failure-related auxiliary information of the first model or the module of the first model; and
an action indication of the first communication device.

6. The method of claim 4, wherein the fallback action comprises:
falling back to an original model;
falling back to an original module;
falling back to a default module;
falling back to a default model; or
falling back to a legacy mechanism.

7. The method of claim 1, further comprising:
determining, by the first communication device, the first action to be performed based on a module importance level,
wherein the module importance level comprises a priority of the module and/or a priority threshold, and the priority of the module corresponds to the first action.

8. The method of claim 1, wherein performing, by the first communication device, the first action comprises:
performing, by the first communication device, a fallback action based on performance of an original model or an original module.

9. The method of claim 8, wherein performing, by the first communication device, the fallback action based on the performance of the original model or the original module comprises:
falling back to the original model or the original module when the performance of the original model or the original module is higher than a performance indicator threshold; and
falling back to a default model, a default module, or a legacy mechanism when the performance of the original model or the original module is not higher than the performance indicator threshold.

10. The method of claim 1, wherein performing, by the first communication device, the first action comprises:
performing, by the first communication device, a default action based on the first model, wherein the default action comprises an action, pre-configured by a second communication device, of the first communication device when the first model is in the update abnormal state,
wherein the default action comprises at least one of:
falling back to an original model or an original module, falling back to a default model or a default module, and falling back to a legacy mechanism.

11. The method of claim 10, further comprising:
reporting, by the first communication device, capability information to the second communication device, wherein the capability information comprises at least one of: whether the first communication device supports falling back to an original model or an original module, whether the first communication device supports falling back to a default model or a default module, and a precision requirement of the first communication device for model prediction.

12. The method of claim 1, further comprising:
receiving, by the first communication device, a default configuration from a second communication device, wherein the default configuration is associated with the first model and/or a module of the first model that needs to be updated.

13. The method of claim 12, further comprising:
receiving, by the first communication device, default-configuration update information, wherein the default-configuration update information is in at least one of a system broadcast message or a terminal-dedicated radio resource control (RRC) message; and
updating, by the first communication device, the default configuration according to the default-configuration update information.

14. The method of claim 12, wherein a case of falling back to or using the default configuration comprises at least one of:
a decoding failure and/or a compliance check failure occurring during the process of updating the first model;
the first communication device performing cell handover;
a change occurring in radio resource configuration information related to the first model; and
determining, based on a monitoring result of the first model, that performance of the first model does not satisfy a pre-configured threshold.

15. The method of claim 12, wherein a behavior of the first communication device complying with a case of falling back to the default configuration comprises at least one of:
a case of falling back to or using the default configuration occurring at the first communication device;
the first communication device being unable to send a first report, unable to fall back to an original model or an original module, or unable to fall back to a legacy mechanism; and
the first communication device determining not to send the first report, not to fall back to the original model or the original module, or not to fall back to the legacy mechanism.

16. The method of claim 12, further comprising:
receiving, by the first communication device, third information from the second communication device, wherein the third information indicates whether the first model or the module of the first model falls back to the default configuration.

17. A second communication device, comprising:
a memory configured to store a computer program; and
a processor configured to invoke and execute the computer program stored in the memory, to cause the communication device to:
send first information used for updating a first model.

18. The second communication device of claim 17, wherein the processor is further configured to invoke and execute the computer program stored in the memory to cause the communication device to:
send second information to a first communication device, wherein the second information is used for indicating a first action performed by the first communication device when the first model is in an update abnormal state.

19. The second communication device of claim 18, wherein the second information is associated with the first model and/or a module of the first model, and the second information is used for indicating the first action corresponding to the first model and/or the module of the first model that needs to be updated.

20. A first communication device, comprising:
a memory configured to store a computer program; and
a processor configured to invoke and execute the computer program stored in the memory, to cause the first communication device to:
receive first information used for updating a first model; and
perform a first action when the first model is in an update abnormal state during a process of updating the first model based on the first information.
